(19) United States
(12) Patent Application Publication
(10) Pub. No.: US 2005/0008859 A1
(43) Pub. Date: Jan. 13, 2005

(54) Method for the preparation of aggregates

(76) Inventor: Haim Forgacs, Beer-Sheva (IL)

Correspondence Address: Martin Moynihan;Anthony Castorina, Suite 207, 2001Jefferson Davis Highway, Arlington, VA, 22202, US

(21) Appl. No.: 10/495,121

(22) PCT Filed: Nov. 19, 2002
(86) PCT No.: PCT/IL02/00921

(30) Foreign Application Priority Data
Nov. 20, 2001 (IL) 146598

(51) Int. Cl. B32B 5/16

(52) U.S. Cl. 428/403

(57) ABSTRACT

A method for the preparation of aggregates (as herein defined) comprising the following steps: 1. providing core materials selected from the group consisting of particulate and granular material in a predetermined size range; 2. admixing said core materials with a coating composition comprising a. a film forming agent (about 10%-20% by weight). b. a gluing agent (5%-10% by weight) and c. a volatile solvent (70%-90% by weight) in which both, the film forming agent and the gluing agent are soluable, and removing thereafter substantially all of said solvent from the mixture of core materials and coating composition, thereby to deposit on said core materials an adherent first coat being at least 1% of the aggregate; 3. and applying to the core materials having said adherent first coat thereon, a second coat which is bonded to said core material by said adherent first coat, said second coat being at least 5% of said aggregate comprising a hydrophobic fume silicate or any other superhydrophobic powder thereby to provide a hydrophobic composite.

The present invention relates to a method for the preparation of aggregates.

Said aggregates and their preparation are described in U.S. Pat. No. 4,474,852. The method claimed in said patent for the preparation of said aggregates comprise the following steps:
a. providing core materials selected from the group consisting of particulate and granular material in a predetermined size range;
b. admixing said core materials with a coating composition comprising, by weight, from about 10% to about 20% of a film-forming polyurethane, from 0% to about 10% of asphalt and from about 70% to about 90% of a volatile solvent in which said film-forming polyurethane and asphalt are soluble, and removing substantially all of said solvent from the mixture of core materials and coating composition, thereby to deposit on said core materials and adherent first coat; and
c. applying to the core materials having said adherent first coat thereon, a second coat which is bonded to said core material by said adherent first coat, said second coat comprising a hydrophobic colloidal oxide of an element selected from the group consisting of silicon, titanium, aluminum, zirconium, vanadium, chromium, iron or mixtures thereof thereby to provide a hydrophobic composite.

However the aggregates prepared by said methods are not satisfactory, as they do not withstand water pressure higher that 2 to 3 centimeters and do not absorb oil or other apolar liquids irreversibly. It has to be stated that unless at least 5% of asphalt was present, the aggregate could not be prepared.

It was thus desirable to improve the characteristics of said aggregates, in particular for:
a. hydrophobic roof coating;
b. hydrophobic wall coating;
c. sealing of basements and other constructions; and
d. irreversible adsorption of crude oil and other apolar liquids for the treatment of oil spills, solidification and disposal of industrial wastes, and related applications.
   In order to develop hydrophobic aggregates suitable for these purposes, certain parameters had to be defined.
   The following parameters have been chosen to characterize hydrophobic aggregates:
   1. a loose (unpacked) layer of hydrophobic aggregate which should hold at least 30 cm of water; and
   2. a hydrophobic aggregate which should adsorb irreversibly apolar liquids. The concentration of the organic material in an aqueous phase in equilibrium with a hydrophobic aggregate saturated with an apolar liquid should be less than 10 ppm TOC.
   After analyzing the experimental results and comparing them with the claims of the above U.S. patent, we concluded, that in order to achieve the goals listed above, we have to change the following parameters:
   1. the composition of the first coat;
   2. the composition of the second coat;
   3. the relative amount of the first and second coat;
   4. the temperature in the various stages of the process; and
   5. the rate of mixing of the aggregate and the coating materials in the course of the preparation.

The parameter of rate of mixing seems to be one of the critical parameters, and is not related to in the above U.S. patent.

The present invention thus consists in a method for the preparation of aggregates (as herein defined) comprising the following steps:
1. providing core materials selected from the group consisting of particulate and granular material in a predetermined size range;
2. admixing said core materials with a coating composition comprising a. a film forming agent, e.g. polyurethane (about 10%-20% by weight). b. a gluing agent, e.g. liquid asphalt, linseed oil, silicon oil (5%-10% by weight) and c. a volatile solvent (70%-90% by weight) in which both, the film forming agent and the gluing agent are soluble, and removing thereafter substantially all of said solvent from the mixture of core materials and coating composition, thereby to deposit on said core materials an adherent first coat being at least 1% of the aggregate;
3. and applying to the core materials having said adherent first coat thereon, a second coat which is bonded to said core material by said adherent first coat, said second coat being at least 5% of said aggregate comprising a hydrophobic fume silicate or any other superhydrophobic powder thereby to provide a hydrophobic composite.

Core materials are e.g. local raw aggregates

material such as: porcelanit, porcelain, dolomite, basalt, sand-quartz, vermiculite, fly or bottom ash, zeolite, chalk, montmolonite, agapultite, flint, bentonite, etc

The method is preferably performed at the following temperatures (all temperatures are given in degrees centigrade).
1. the core material is dried at 100°-140°, preferably 120°.
2. thereafter it is cooled to 50°-70°, preferably 60°.
3. the first coat is added and the composition is then heated to 100°-140°, preferably 120°.
4. after most of the solvent has evaporated, the second coat is reheated at utmost 140°, preferably 120°.

The rate of mixing should be controlled. The optimal rate of mixing is about 25-35 rpm, advantageously 30 rpm.

The amount of coating material required is dependant on the particle size of the core material.

The present invention will now be illustrated with reference to the accompanying Example without being limited by it.
1. PREPARATION OF HYDROPHOBIC COATINGS
   1. Materials
      The coating is consisting of two ingredients: a. glue mixture and b. hydrophobic fume silica.
      a. Glue mixture: The glue mixture is prepared by mixing 10% (w) of polyurethane, 10% (w) of liquid asphalt and 80% (w) paint thinner solvent. The polyurethane used in our experiment was Alkydal F 48/55% in benzene-xylol (manufactured by Bayer). The liquid asphalt was obtained from the Pazkar Co., and as thinner commercial grades of thinners were used.
      b. The hydrophobic fume silica is produced by Degussa and the grade used was #R812.
   2. Procedure
      The following laboratory procedure was used in coating the aggregates.
         The first step was to dry the aggregates at 105° C. to less than 1% of moisture. Glue mixture heated at 90° C. was added to the dried aggregates. The amount of glue mixture added usually did not exceed 2% of the weight of the aggregates and mixed at temperatures of around 1100-120° C. Care was taken in maintaining this temperature during the mixing process and the ingredients were checked periodically for complete evaporation of the solvents. Hydrophobic fume silica is added to the coated aggregates while hot and mixed until the disappearance of the silica “cloud”. The aggregates are then spread out and exposed to the air and allowed to cool for 24 hours before use.

1. A method for the preparation of aggregates (as herein defined) comprising the following steps:
a. providing core materials selected from the group consisting of particulate and granular material in a predetermined size range;
b. admixing said core materials with a coating composition comprising a. a film forming agent (about 10%-20% by weight). b. a gluing agent (5%-10% by weight) and c. a volatile solvent (70%-90% by weight) in which both, the film forming agent and the gluing agent are soluble, and removing thereafter substantially all of said solvent from the mixture of core materials and coating composition, thereby to deposit on said core materials an adherent first coat being at least 1% of the aggregate;
c. and applying to the core materials having said adherent first coat thereon, a second coat which is bonded to said core material by said adherent first coat, said second coat being at least 5% of said aggregate comprising a hydrophobic fume silicate or any other superhydrophobic powder thereby to provide a hydrophobic composite.

2. A method according to claim 1, wherein the film forming agent is polyurethane and the gluing agent is selected among liquid asphalt, linseed oil and silica oil.

3. A method according to claim 1, wherein the superhyrophobic powder is a hydrophobic fume silicate.

4. A method according to claim 1, wherein the core material is selected among local raw aggregates material such as: porcelanit, porcelain, dolomite, basalt, sand-quartz, vermiculite, fly or bottom ash, zeolite, chalk, montmolonite, agapultite and flint, bentonite.

5. A method according to claim 1 which is performed at the following temperatures (all temperatures are given in degrees centigrade).
a. the core material is dried at 100°-140°.
b. thereafter it is cooled to 50°-70°.
c. the first coat is added and the composition is then heated to 100°-140°.
d. after most of the solvent has evaporated, the second coat is reheated at utmost 140°.

6. A method according to claim 5 wherein
a. the core material is dried at 120°;
b. thereafter the core material is cooled to 60°;
c. the composition is then heated to 120°; and
d. then the composition is reheated to 120°.

7. A method according to claims 1, wherein the rate of mixing is 25 to 35 rpm.

8. A method according to claim 7, wherein the rate of mixing is 30 rpm.

9. A method for the preparation of aggregates as defined in claim 1, substantially as described in the Specification.

10. An aggregate as herein defined whenever prepared by the method according to claim 1.
